(19) United States
(12) Patent Application Publication
(10) Pub. No.: US 2008/0027849 A1
(43) Pub. Date: Jan. 31, 2008

(54) Stipulated trading system

(75) Inventor: Clifford Paul Ribaudo, Jersey City, NJ (US)

Correspondence Address: John M. Johnson;Carter Ledyard & Milburn LLP, 2 Wall Street, New York, NY, 10005, US

(73) Assignee: Beacon Capital Strategies, LLC

(21) Appl. No.: 11/494,875

(22) Filed: Jul. 28, 2006

(51) Int. Cl. G06Q 40/00

(52) U.S. Cl. 705/37

(57) ABSTRACT

A system and method for a transaction involving any asset that is substantially fungible within a predetermined asset class comprising a component for populating a database with first data including asset identification indicia for at least one asset that is substantially fungible within a predetermined asset class; a component for matching said data with second data of others with access to said database, said data of others including asset identification indicia for at least one asset that is substantially fungible within a predetermined asset class; and a component for notifying of said match between said first data and said second data.

### BACKGROUND OF THE INVENTION

The purpose of this invention is to facilitate the electronic trading of classes of assets where interested buyers or sellers indicate the characteristics of the asset they are willing to buy or sell rather than a specific asset. The need for this ability arises when the number of unique assets issued is very large and the finding of the holders of any specific asset is difficult and not all that important. For example, Mortgage Backed Securities (Specified Pools) or Municipal Bonds and certain types of other Asset Backed Securities.

In these classes of assets buyers rarely look for specific items (as denoted by their unique id or CUSIP) but rather those with the characteristics they want, and any asset with those characteristics will do. And for these types of assets sellers sometimes do not wish to state exactly what they are selling but would rather anonymously announce the offering of something with a specified state of characteristics.

Furthermore many holders of such assets are not required to publish what they are holding making it difficult for interested parties to find holders willing to sell or buy more of a specific holding or something like it. This has required the end consumers to use Brokers who try to find what is needed from amongst their contacts, for which service they charge substantial fees.

An electronic marketplace would make this task substantially easier for buyers and sellers, however the large number of assets in the various classes of assets makes the traditional approach used on many electronic markets of having a “standing” market for specific assets, with a guaranteed Bid and Offer, impractical. The impracticality stems from the fact that it is simply not possible to be holding inventory of all the assets making it impossible for people who make markets in the various asset classes to be able to guarantee delivery (due to uncertainty of locating it) or the price.

### SUMMARY OF THE INVENTION

The subject invention solves this problem by enabling the ultimate end buyers and sellers for these types of assets to bypass Brokers and to electronically locate and transact in them. It does this by allowing users to privately list (not seen by anyone other than the lister) the following:
1) Their holdings of specific assets in a database, where that listing includes the assets unique catalogue id and class and thereby identifying it and all known published characteristics of it. The private nature of the listing ensures that no party other than the lister may know of the existence of the listing until such time as the lister wishes. And their intention for the holding which can be specified as either:
   a) Willingness to sell the listed asset to parties seeking it or assets with it's characteristics.
   b) Willingness to buy more of the listed asset or others with characteristics like it.
2) Their specifications for the type of assets they would like to buy or sell. In this case (as opposed to 1) they list the specifications of assets they are interested in, rather than the assets themselves.

The subject invention then allows users to notify other users of the system of their intention to buy or sell an asset. They do this in one of the following ways:
1) Intention to buy a specific asset with stated unique id. The system then evaluates the listed specifications of other users on the system and informs them that they have the matching specification to be the seller. The system will inform the following types of users:
   a) Those who have the same asset and whose specifications indicate they would sell it.
   b) Those who have listed specifications to sell assets like what the buyer has specified.
2) Intention to sell a specific asset with stated unique id. The system then evaluates the listed specifications of other users on the system and informs them that they have matching specification to be the buyer. The system will inform the following types of users:
   a) Those who have the same asset and whose specifications indicate they will buy more of it.
   b) Those who have listed specifications to buy assets like what the seller is offering.
3) Intention to buy an asset with the stated specifications. The system then evaluates the listed specifications of other users on the system and informs them that they have matching specifications to be the seller. The system will inform the following types of users:
   a) Sellers who have listed assets that match the specification.
   b) Sellers who listed that they are willing to sell assets like what the buyer has specified.
4) Intention to sell an asset with the stated specifications. The system then evaluates the listed specifications of other users on the system and informs them that they have matching specifications to be the buyer. The system will inform the following types of users:
   a) Buyers who have listed assets that match the specification.
   b) Buyers who listed that they are willing to buy assets like what the seller has specified.

The subject invention ensures that the Responders to stipulated or specified orders only respond with assets that conform to the specifications of the Sender. The actual method for negotiating the exchange of assets in this type of system are covered by under two other patents: One Sided Limit Order Book and the Stipulated Limit Order Book.

### BRIEF DESCRIPTION OF THE DRAWINGS

These and other subjects, features and advantages of the present invention will become more apparent in light of the following detailed description of a best mode embodiment thereof, as illustrated in the accompanying Drawings.

The invention is described by reference to the accompanying drawings and corresponding examples in which:

FIG. 1 is a schematic representation of a system for trading in accordance with an embodiment of the invention;

FIG. 2 is a flow chart depicting the general method of conducting a specified trade on the invention;

FIG. 2.a is a flow chart depicting the process of submitting an inventory of assets to the invention;

FIG. 2.b is a flow chart depicting the process of submitting specifications or stipulations to buy or sell assets;

FIG. 2.c is a flow chart depicting the process used by users to notify other users of their desire to buy or sell assets;

FIG. 2.d is a flow chart depicting the process used by the invention to translate user notification of desire to buy and sell into corresponding and complimentary opportunity for other users of the invention;

FIG. 2.e is a flow chart depicting in the detail the process used by the invention to identify the User's corresponding and complimentary opportunities for any notification; and

FIG. 2.f is a flow chart depicting the process of responding to notification of opportunity to trade an asset with the initiator of the notification.

### DETAILED DESCRIPTION OF THE INVENTION

The purpose of this invention is to facilitate the electronic trading of classes of assets between financial institutions where interested buyers or sellers indicate the characteristics of the asset they are willing to buy or sell rather than a specific asset.

The invention is implemented via user software and exchange software that in total embodies the capabilities of the invention. Non-limiting examples of the types of software languages that can be employed to code the software of the subject invention include, but are not limited to, PASCAL, C, C++ and JAVA.

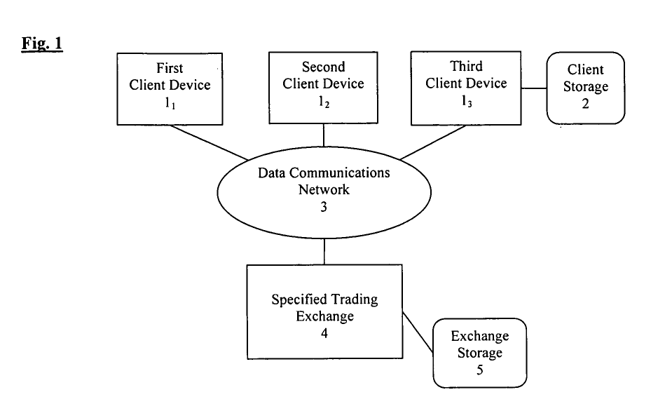

Referring to FIG. 1, the diagram generally depicts a system for trading on the invention. The system depicted by FIG. 1, comprises a plurality of workstations 1₁,1₂,1₃ (generally referred to herein as workstation(s)). All workstations are connected to a data communications network such as (but not exclusively) the internet, herein generally referred to as the network(s). The subject invention is cross-platform hardware computable, including but not limited to, Intel PC, UNIX and PowerPC, for example. Where Intel-based workstations are employed, by non-limiting example, they can be are preferably IBM compatible PC computers each having an Intel Pentium-based central processing unit with 512 MB of RAM and a Linux or Microsoft Windows XP operating system.

Each workstation belongs to users wishing to use the invention to trade assets on the Exchange 4, herein generally referred to as the Exchange. Workstations may be any type of computing device, operable to run the inventions user software. Workstations, communicate via the user software with the exchange over networks. Workstations may (or may not) have data storage, attached or locally available as depicted in FIG. 1, Client Storage 2, herein generally referred to as Client Storage.

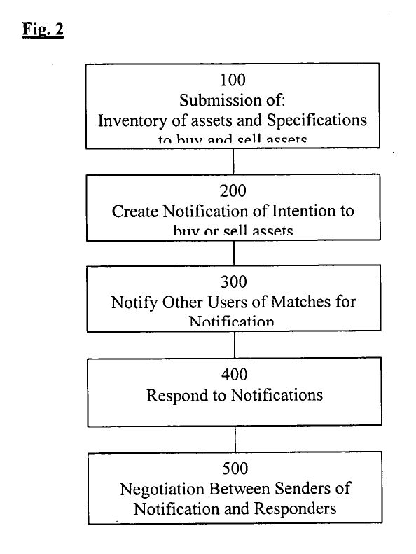

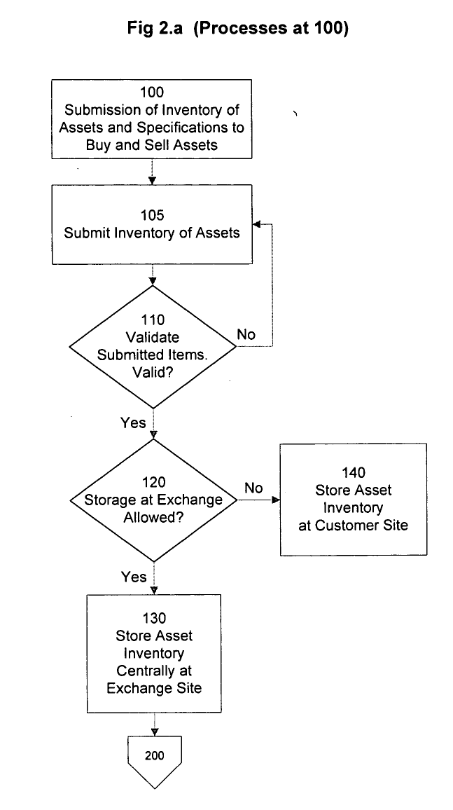

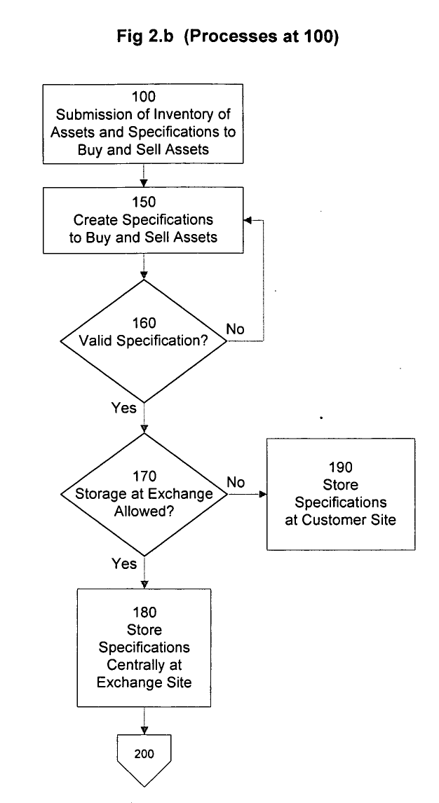

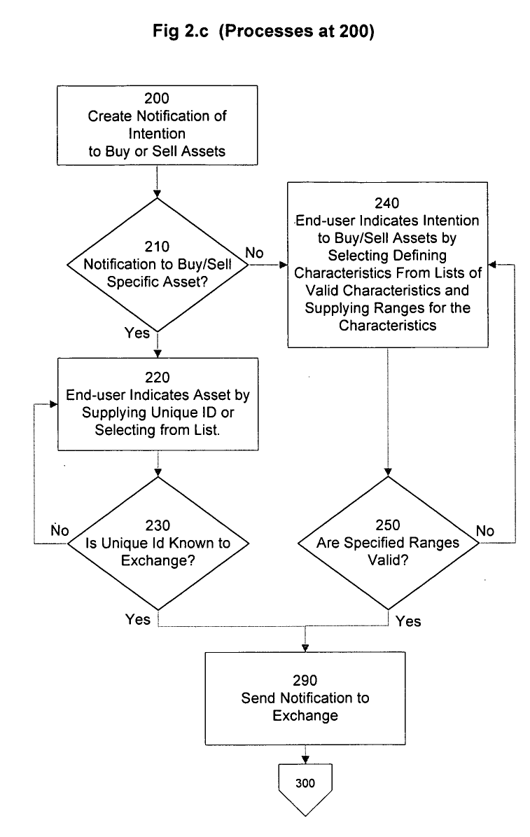

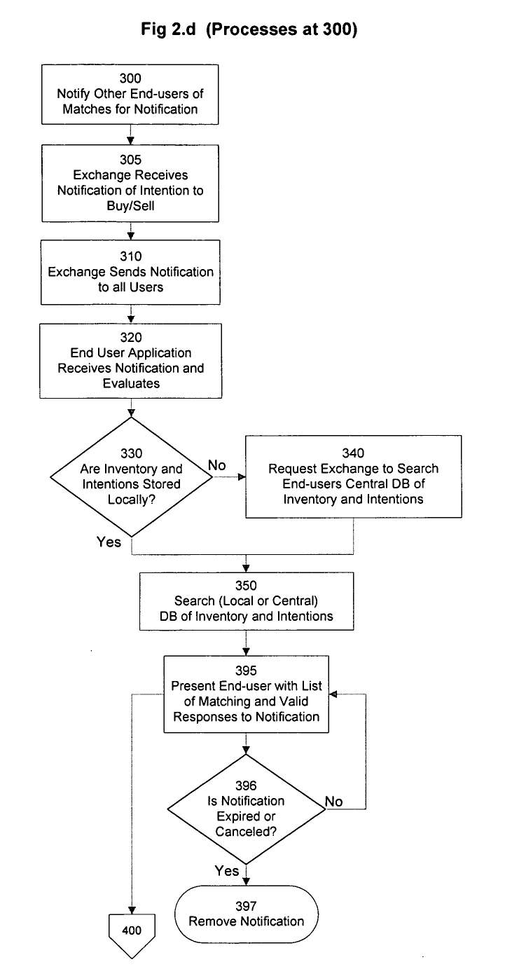

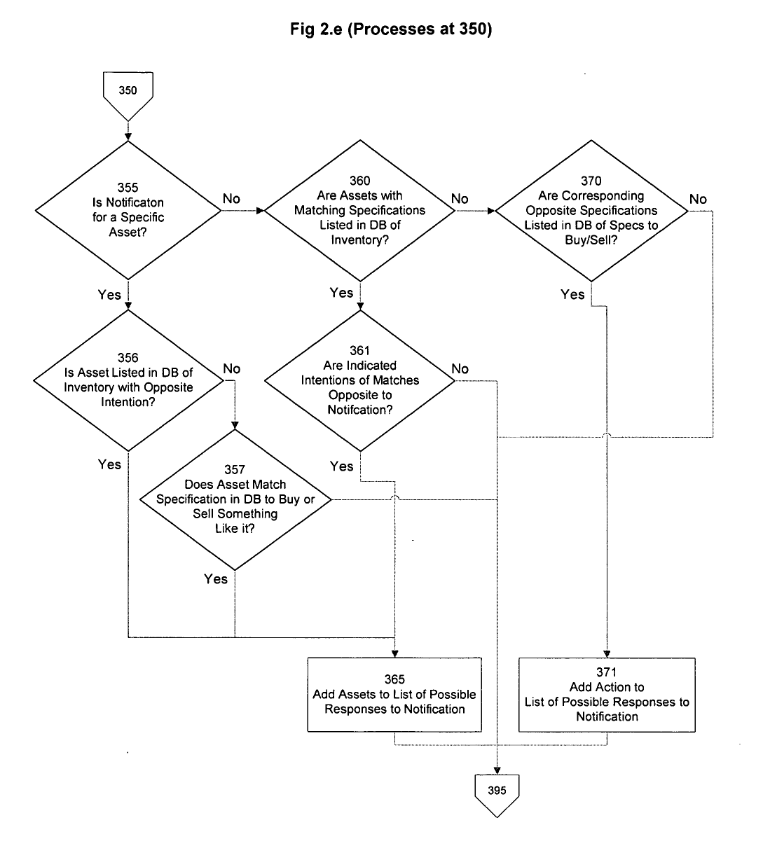

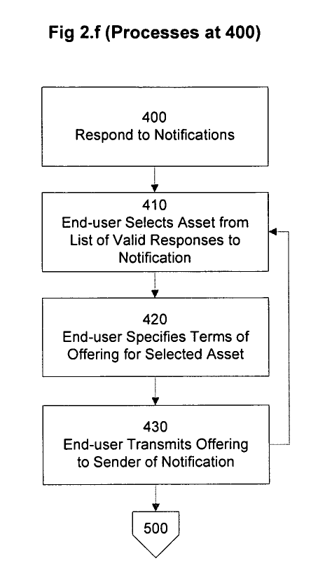

FIG. 2 generally depicts the steps a user running the inventions user software on a workstation takes when using the invention to trade assets.

FIG. 2, 100 generally depicts the processes associated with a customer using the user software on a workstation to submit data files to the invention. These data files contain the following types of information:
a) The unique identifier of assets that can be traded on the system and which the customer owns.
b) The specifications for assets they might buy and sell, but do not wish to identify as inventory or by unique id.

These data files make it possible for the invention to inform the submitting user when other users on other workstations, are looking to buy or sell assets like those the submitter has listed in inventory or specifications. The processes at FIG. 2, 100 are optional and users are not required to submit such files to use the invention.

The processes generally depicted at FIG. 2, 100 are depicted in detail in FIG. 2.a, and FIG. 2.b. Referring to FIG. 2.a, the processes at 100, indicate a user running the inventions user software on a workstation. At FIG. 2.a, 105 the user invokes the user software's upload function. This function receives a data file containing the unique identifier of the inventory of assets the user wishes to make known to the invention.

Then at FIG. 2.a, 110 the invention processes the file, validating each submitted unique identifier against various criteria, such as (but not exclusively) existence in a master inventory list. Those passing the validation tests are accepted and those that do not are rejected.

Next, at FIG. 2.a, 120 the invention takes the list of accepted items and places it in a data file that is private to the submitter. The location of this data file depends on where the user instructed the invention to store it. They have the option to have the data file reside on their premises or in central storage at the exchange. If the user instructed the invention to store it locally, the processes depicted at FIG. 2.a 140, will store it in local storage depicted at FIG. 1, Client Storage 2. If the user instructed the Invention to store it centrally, the processes depicted at FIG. 2.a 130 will store it centrally, depicted at FIG. 1, exchange storage 5.

Referring to FIG. 2.b, the processes at 100, indicate a user running the inventions user software on a workstation. At FIG. 2.b, 150 the user invokes the user software's buy/sell specification creator. This function allows the user to create and define one or more specifications describing the types of assets they wish to buy and sell. The invention uses the users specifications to filter notifications that arrive from other users. The invention shows users only those notifications about assets whose characteristics fall within the parameters of their specification.

Specifications consist of lists of any of the published characteristics for the type of asset and the allowable range of values for those specifications. For example, if the user is seeking to trade Mortgage Backed Securities (MBS) on the invention, they might create the following specification:

### EXAMPLE 1

TRANSACTION TYPE=seller;

ASSET=MBS;

CHARACTERISTICS: Issuer=FNMA; WAC>=4 & <=4.5.

At FIG. 2.b, 160 the invention processes the specification, validating the description. Those that conform to the inventions rules of syntax, and use characteristics known to the invention are accepted. Those that do not are returned to the user for correction.

Next, at FIG. 2.b, 170 the invention stores the specifications in a data file that is private to the submitter. The location of this data file depends on where the user instructed the invention to store it. If the user instructed the invention to store it locally, the processes depicted at FIG. 2.b, 190, will store it in local storage depicted at FIG. 1, Client Storage 2. If the user instructed the invention to store it centrally, the processes depicted at FIG. 2.b, 180 will store it centrally, depicted at FIG. 1, Exchange Storage 5.

Referring to FIG. 2, the processes at 200 depict, in general, the use of the invention by a user to create a notification of their intention to buy or sell assets on the invention and to send it to the exchange for transmission to other users of the invention. The processes at 200 are detailed in FIG. 2.c. Referring to FIG. 2.c a user of the invention at FIG. 2.c, 200, invokes the user software's function to create notifications.

Users may create 2 basic types of notifications. Notifications to buy or sell a specific asset, and notifications to buy or sell any asset(s) as defined by their specified characteristics. At FIG. 2.c, 210 users indicate by use of the user software which type of notification should be sent.

When the user indicates intention to buy or sell a specific asset the user software presents them with an interface at FIG. 2.c, 220 that allows them to supply either a unique id or to search through the master list of all assets that can be traded on the invention, for the unique id of the asset they wish to send notification of. For the purposes of later discussion, Example 2, illustrates some (not all) of the elements of a notification:

### EXAMPLE 2

TRANSACTION TYPE=buyer; UNIQUE ID=xyz;

Then at FIG. 2.c, 230, the selections unique id is validated. Once validated the processes at FIG. 2.c, 290 sends the users notification to the exchange for transmission to other users.

Alternatively, when users indicate at FIG. 2.c, 210 their intention to send notification by selecting a set of characteristics which define the asset they wish to send notification about. The inventions user software at FIG. 2.c, 240 presents them with an interface that allows them to define characteristics for the asset the User Intends to buy or sell by selecting the criteria and setting values and ranges for them from lists of allowable criteria for the selected asset type. For the purposes of later discussion, Example 2, illustrates some (not all) of the elements of a notification:

### EXAMPLE 3

TRANSACTION TYPE=buyer;

ASSET=MBS;

CHARACTERISTICS: Issuer=FNMA; WAC>=4 & <=4.1.

Once the notification has been defined, it is validated by the processes shown at FIG. 2.c, 250.

After successful validated the processes at FIG. 2.c, 290 sends the users notification to the exchange for transmission to other users.

Referring to FIG. 2 the processes at 300 detail the receipt by the exchange of the notification from it's creator, and the transmission of that to other end-users. The processes at 300 are explained in detail by the diagrams FIG. 2.d and FIG. 2.e.

Referring to FIG. 2.d, the exchange receives the users notification at FIG. 2.d., 305. The processes depicted at FIG. 2.d, 310 send received notifications to all other users of the system. The notification will consist of the criteria defined by the processes at FIG. 2, 200 and shown in Examples 2 and 3.

Other users of the invention receive the notification from the user software running on their workstations. The user software carries out the processes depicted at FIG. 2.d, 320, beginning the process to evaluate received notifications and inform the recipients what their options for action are. This process displays the notification to recipient users so that they are aware of the existence of the possibility for action.

The processes depicted at FIG. 2.d, 330 then determine where the recipient stores the database of inventory and specifications. If they are stored centrally the processes depicted at FIG. 2.d, 340 request the exchange to conduct a search of the users inventory and specifications for possible responses to the notification and if they are stored locally the search is conducted on the local database.

Both types of searches, local or central, use the same procedures, indicated by FIG. 2.d, 350 in general and by the processes depicted in FIG. 2.e in detail.

Referring to FIG. 2.e, the processes at FIG. 2.e, 355 determine if the received notification pertains to a specific security. If the notification does pertain to a specific security, for example, as shown in Example 2, (indicating that the sender of the notification is looking to buy asset XYZ) the processes at FIG. 2.e, 356 will search the recipients database of inventory for asset XYZ. If the asset is found the processes at FIG. 2.e, 356 will submit the listing to the processes at FIG. 2.e, 365, to be added to the list of potential response actions to the notification. The listing will inform the user that he has the opportunity to sell XYZ, listed in his inventory to the sender of the notification should he wish to.

If the processes at FIG. 2.e, 356 do not find the item in inventory, the processes at FIG. 2.e, 357 are requested to evaluate the characteristics of the asset for a match with one or more of the recipients specifications for types of assets they are willing to buy and sell. For example, where the notification from the sender is about the asset shown in Example 2, and the user has a specification in his database like that shown in Example 1, the processes at FIG. 2.e, 357 will lookup the characteristics of the asset XYZ and evaluate them against the recipients specifications for a match. If a match is found the possible actions will be submitted to the processes at FIG. 2.e, 365 to be added to the list of possible actions.

The listing will inform the user that while asset XYZ is not listed in the recipients inventory, the user did indicated the desire to sell an asset like it and should he actually have it in undisclosed inventory there is an opportunity to sell it.

Referring back to the processes at FIG. 2.e, 355 if the notification received by the user is about the characteristics of an asset rather than a specific asset, the processes at FIG. 2.e, 360 will evaluate it.

For example if the notification is like that shown in Example 3, the processes at FIG. 2.e, 360 will search the recipients inventory for all MBS assets, issued by FNMA with WAC>=4 & <=4.1. The processes at FIG. 2.e, 361 further determine if there was any predisposition to buy or sell the matching inventory. Any matching asset with an unspecified disposition to buy or sell, and any asset with a specified disposition to sell will be submitted to the processes at FIG. 2.e, 365 to be added to the list of possible response actions that the recipient can take.

Referring back to the processes at FIG. 2.e, 360, if no items are found in inventory matching the specifications of the received notification, the notification is passed to the processes depicted at FIG. 2.e, 370 for evaluation against the recipients database of specifications for possible actions the Recipient would be willing to take. For example if the notification had the specifications shown in Example 4,

### EXAMPLE 4

TRANSACTION TYPE=seller;

ASSET=MBS;

CHARACTERISTICS: Issuer=FNMA; WAC>=4 & <=4.1.

And the recipient has a specification in the database of specifications like that shown in example 3, the processes at FIG. 2.e, 370, submits to the processes depicted at FIG. 2.e, 371 the following possible actions to be added to the list of possible responses: Request the sender of the notification to offer specific assets with those specifications.

The listing in effect indicates that the sender of the notification is a seller of assets like those the recipient wishes to buy. This can then lead to further communication regarding the specific assets and quantities to be transacted.

The overall effect of the processes defined in FIG. 2.e is to ensure that responders can only reply to senders of notifications with assets that conform to the specifications defined in the notification. The processes defined at FIG. 2.e simply do not allow for non-correlated responses.

Referring back to the previous diagram FIG. 2.d, the processing continues with the processes at FIG. 2.d, 395 where the user software presents the user with a list of all the possible responses to the notification. The notification along with all possible responses is displayed to the user until such time as the sender of the notification cancels it or the allowed time for a response has expired.

At any time prior to the removal of the notification by the processes at FIG. 2.d, 397, the user may respond to the sender of the notification via the processes depicted, in general, in FIG. 2. at 400, and which are detailed in FIG. 2.f.

Referring to the processes detailed in FIG. 2.f, recipients of notifications respond via the interface in the user software depicted at FIG. 2.f, 410, by selecting from the list of valid possible responses. Upon selection of a valid response the processes in the user software depicted at FIG. 2.f, 420 present the user with an interface allowing the user to specify the terms of their participation in the transaction. For example if they are in the role of selling an asset they specify the asset, the amount, the price and any other factors relevant to the sale of that type of asset. Upon completion of specifying the terms the user invokes the processes of the user software depicted at FIG. 2.f, 430 to transmit their response to the sender.

The processes at FIG. 2, 500, illustrate in general the negotiation between a user who sent a notification to trade assets and the recipients who responded. The details of the negotiation process are the subject of other inventions called: One Sided Limit Order book and Stipulated Limit Order Book.

In brief these processes group responses for the same asset together on an embodiment of the One Sided Limit Order Book. And when the specifications defined in the notification allow for responses with multiple and different assets, multiple One Sided Limit Order Books (one per each unique occurrence of an asset) are created. These are grouped together on the Stipulated Limit Order Book.

All responses on a One Sided Limit Order Book are queued so that the “best” response is first according to it's rules. Best, (for the purposes of this explanation) is defined to be the best price from the perspective of the user who sent the Notification. In general, but not always, “Best” means lowest price when the sender is buying, and highest when selling. There are exceptions to this rule, for example if the negotiation is done in terms of yield “best” for a buyer would be highest yielding.

The processes of negotiation at FIG. 2, 500 end when the allotted time expires or the sender cancels his notification.

Although the invention has been shown and described with respect to a best mode embodiment thereof, it should be understood by those skilled in the art that carious changes, omissions, and additions may be made to the form and detail of the disclosed embodiment without departing from the spirit and scope of the invention, as recited in the following claims.

We claim:

1. A system for a transaction involving any asset that is substantially fungible within a predetermined asset class comprising:
a component for populating a database with first data including asset identification indicia for at least one asset that is substantially fungible within a predetermined asset class;
a component for matching said data with second data of others with access to said database, said data of others including asset identification indicia for at least one asset that is substantially fungible within a predetermined asset class; and
a component for notifying of said match between said first data and said second data.

2. The system of claim 1 wherein if said matching fails a second matching is attempted based on different second data of others also present as first data.

3. The system of claim 1 wherein said assets that are substantially fungible within a predetermined asset class are selected from the group of mortgage backed securities, municipal bonds, agency bonds, CMO's, REMIC's and asset backed securities.

4. The system of claim 1 wherein at least one entity in said transaction remains anonymous.

5. The system of claim 1 wherein said asset identification indicia is the CUSIP (committee on uniform securities processes), SEDOL (stock exchange daily official list), or ISIN (informational securities identification number) of said asset.

6. A system for a transaction involving any asset that is substantially fungible within a predetermined asset class comprising:
a component for populating a database with first data including asset identification indicia for at least one asset that is substantially fungible within a predetermined asset class;
a component for matching said data with second data of others with access to said database, said data of others including generally known and published characteristics of at least one asset that is substantially fungible within a predetermined asset class other than asset identification indicia; and
a component for notifying of said match between said first data and said second data.

7. The system of claim 6 wherein if said matching fails a second matching is attempted based on different second data of others also present as first data.

8. The system of claim 6 wherein said assets that are substantially fungible within a predetermined asset class are selected from the group of mortgage backed securities, municipal bonds, agency bonds, CMO's, REMIC's and asset backed securities.

9. The system of claim 6 wherein at least one entity in said transaction remains anonymous.

10. The system of claim 7 wherein said asset identification indicia is the CUSIP (committee on uniform securities processes), SEDOL (stock exchange daily official list), or ISIN (informational securities identification number) of said asset.

11. A system for a transaction involving any asset that is substantially fungible within a predetermined asset class comprising:
a component for populating a database with first data including general generally known and published characteristics of at least one asset that is substantially fungible within a predetermined asset class other th asset identification indicia;
a component for matching said data with second data of others with access to said database, said data of others including asset identification indicia for at least one asset that is substantially fungible within a predetermined asset class; and
a component for notifying of said match between said first data and said second data.

12. The system of claim 11 wherein if said matching fails a second matching is attempted based on different second data of others also present as first data.

13. The system of claim 11 wherein said assets that are substantially fungible within a predetermined asset class are selected from the group of mortgage backed securities, municipal bonds, agency bonds, CMO's, REMIC's and asset backed securities.

14. The system of claim 11 wherein at least one entity in said transaction remains anonymous.

15. The system of claim 11 wherein said asset identification indicia is the CUSIP (committee on uniform securities processes), SEDOL (stock exchange daily official list), or ISIN (informational securities identification number) of said asset.

16. A system for a transaction involving any asset that is substantially fungible within a predetermined asset class comprising:
a component for populating a database with first data including generally known and published characteristics of at least one asset that is substantially fungible within a predetermined asset class other than asset identification indicia;
a component for matching said data with second data of others with access to said database, said data of others including generally known and published characteristics of at least one asset that is substantially fungible within a predetermined asset class other than asset identification indicia; and
a component for notifying of said match between said first data and said second data.

17. The system of claim 16 wherein if said matching fails a second matching is attempted based on different second data of others also present as first data.

18. The system of claim 16 wherein said assets that are substantially fungible within a predetermined asset class are selected from the group of mortgage backed securities, municipal bonds, agency bonds, CMO's, REMIC's and asset backed securities.

19. The system of claim 16 wherein at least one entity in said transaction remains anonymous.

20. The system of claim 16 wherein said asset identification indicia is the CUSIP (committee on uniform securities processes), SEDOL (stock exchange daily official list), or ISIN (informational securities identification number) of said asset.

21. A method for a transaction involving any asset that is substantially fungible within a predetermined asset class comprising:
populating a database with first data including asset identification indicia for at least one asset that is substantially fungible within a predetermined asset class;
matching said data with second data of others with access to said database, said data of others including asset identification indicia for at least one asset that is substantially fungible within a predetermined asset class; and
notifying of said match between said first data and said second data.

22. The method of claim 21 wherein if said matching fails a second matching is attempted based on different second data of others also present as first data.

23. The method of claim 21 wherein said assets that are substantially fungible within a predetermined asset class are selected from the group of mortgage backed securities, municipal bonds, agency bonds, CMO's, REMIC's and asset backed securities.

24. The method of claim 21 wherein at least one entity in said transaction remains anonymous.

25. The method of claim 21 wherein said asset identification indicia is the CUSIP (committee on uniform securities processes), SEDOL (stock exchange daily official list), or ISIN (informational securities identification number) of said asset.

26. A method for a transaction involving any asset that is substantially fungible within a predetermined asset class comprising:
populating a database with first data including asset identification indicia for at least one asset that is substantially fungible within a predetermined asset class;
matching said data with second data of others with access to said database, said data of others including general generally known and published characteristics of at least one asset that is substantially fungible within a predetermined asset class other than asset identification indicia; and
notifying of said match between said first data and said second data.

27. The method of claim 26 wherein if said matching fails a second matching is attempted based on different second confidential data of others also present as first confidential data.

28. The method of claim 26 wherein said assets that are substantially fungible within a predetermined asset class are selected from the group of mortgage backed securities, municipal bonds, agency bonds, CMO's, REMIC's and asset backed securities.

29. The method of claim 26 wherein at least one entity in said transaction remains anonymous.

30. The method of claim 26 wherein said asset identification indicia is the CUSIP (committee on uniform securities processes), SEDOL (stock exchange daily official list), or ISIN (informational securities identification number) of said asset.

31. A method for a transaction involving any asset that is substantially fungible within a predetermined asset class comprising:
populating a database with first data including generally known and published characteristics of at least one asset that is substantially fungible within a predetermined asset class other than asset identification indicia;
matching said data with second data of others with access to said database, said data of others including asset identification indicia for at least one asset that is substantially fungible within a predetermined asset class; and
notifying of said match between said first data and said second data.

32. The method of claim 31 wherein if said matching fails a second matching is attempted based on different second data of others also present as first data.

33. The method of claim 31 wherein said assets that are substantially fungible within a predetermined asset class are selected from the group of mortgage backed securities, municipal bonds and asset backed securities.

34. The method of claim 31 wherein at least one entity in said transaction remains anonymous.

35. The method of claim 31 wherein said asset identification indicia is the CUSIP (committee on uniform securities processes), SEDOL (stock exchange daily official list), or ISIN (informational securities identification number) of said asset.

36. A method for a transaction involving any asset that is substantially fungible within a predetermined asset class comprising:
populating a database with first data including generally known and published characteristics of at least one asset that is substantially fungible within a predetermined asset class other than asset identification indicia;
matching said data with second data of others with access to said database, said data of others including generally known and published characteristics of at least one asset that is substantially fungible within a predetermined asset class other than asset identification indicia; and
notifying of said match between said first data and said second data.

37. The method of claim 36 wherein if said matching fails a second matching is attempted based on different second data of others also present as first data.

38. The method of claim 36 wherein said assets that are substantially fungible within a predetermined asset class are selected from the group of mortgage backed securities, municipal bonds, agency bonds, CMO's, REMIC's and asset backed securities.

39. The method of claim 36 wherein at least one entity in said transaction remains anonymous.

40. The method of claim 36 wherein said asset identification indicia is the CUSIP (committee on uniform securities processes), SEDOL (stock exchange daily official list), or ISIN (informational securities identification number) of said asset.
